(19) United States
(12) Patent Application Publication
(10) Pub. No.: US 2008/0317974 A1
(43) Pub. Date: Dec. 25, 2008

(54) Method and Arrangement for Generating and Controlling a Discharge Plasma

(75) Inventors: Hindrik Willem de Vries, Tilburg (NL); Eugen Aldea, Eindhoven (NL); Jan Bastiaan Bouwstra, Bilthoven (NL); Mauritius Cornelius Maria van de Sanden, Tilburg (NL)

Correspondence Address: FOLEY AND LARDNER LLP;SUITE 500, 3000 K STREET NW, WASHINGTON, DC, 20007, US

(73) Assignee: FUJIFILM MANUFACTURING EUROPE B.V.

(21) Appl. No.: 12/064,708

(22) PCT Filed: Aug. 24, 2006
(86) PCT No.: PCT/NL2006/050209

§ 371 Date: Aug. 11, 2008

(30) Foreign Application Priority Data
Aug. 26, 2005 (EP) 05107851.7

(51) Int. Cl. B01J 19/08; H05B 41/36; H01J 7/24

(52) U.S. Cl. 427/569; 315/307; 315/111.21

(57) ABSTRACT

Method and arrangement for controlling a discharge plasma in a discharge space (11) having at least two spaced electrodes (13, 14). A gas or gas mixture is introduced in the discharge space (11), and a power supply (15) for energizing the electrodes (13, 14) is provided for applying an AC plasma energizing voltage to the electrodes (13, 14). At least one current pulse is generated and causes a plasma current and a displacement current. Means for controlling the plasma are provided and arranged to apply a displacement current rate of change for controlling local current density variations associated with a plasma variety having a low ratio of dynamic to static resistance, such as filamentary discharges. By damping such fast variations using a pulse forming circuit (20), a uniform glow discharge plasma is obtained.

### FIELD OF THE INVENTION

The present invention relates in general to a method and control arrangement for generating and controlling a discharge plasma, such as a glow discharge plasma. More in particular, the present invention relates to a method for controlling a discharge plasma in a gas or gas mixture, in a plasma discharge space having at least two spaced electrodes, in which at least one current pulse is generated by applying an AC plasma energizing voltage to the electrodes causing a plasma current and a displacement current. In a further aspect the present invention relates to an arrangement for generating and controlling a discharge plasma in a discharge space having at least two spaced electrodes, means for introducing a gas or gas mixture in the discharge space, a power supply for energizing the electrodes by applying an AC plasma energizing voltage to the electrodes for generating at least one current pulse and causing a plasma current and a displacement current, and means for controlling the plasma. The present method and arrangement are well suited for generating a plasma under substantially atmospheric conditions (such as an Atmospheric Pressure Glow discharge plasma), but may be applied in a wide range of pressures, e.g. from 0.1 to 10 bar.

### PRIOR ART

Atmospheric Pressure Glow (APG) discharge plasma is used in practice, among others, for non-destructive material surface modification. Glow discharge plasmas are relatively low power density plasmas, typically generated under vacuum conditions or partial vacuum environments.

Most commonly, the plasma is generated in a plasma chamber or plasma discharge space between two oppositely arranged parallel plate electrodes. However, the plasma may also be generated using other electrode configurations such as, for example, adjacently arranged electrodes. Recently interest has grown in creating a plasma at atmospheric pressure. The plasma is generated in a gas or a gas mixture by energizing the electrodes from AC power supply means.

It has been observed that a stable and uniform plasma can be generated in, for example, a pure Helium or a pure Nitrogen gas. However, as soon as impurities or other gasses or chemical compositions at ppm level are present in the gas, the stability of the plasma will decrease significantly. Typical examples of stability destroying components are O2, NO, CO2, etc.

Instabilities in the plasma will either develop in a high current density plasma or will extinguish the plasma locally. With a large density of species and a high frequency of collisions in the plasma, an APG shows a fast positive feedback. That is, a random local increase of the ionization of the plasma will exponentially increase. Accordingly, an instability will develop either in a high current density plasma or will extinguish the plasma locally. The phenomenon of exponential increase of the plasma current is known as glow to arc transition. As a result, current arcing occurs and the glow discharge plasma can not be maintained. Instead, a combination of filamentary and glow discharge is generated.

Filamentary discharge between parallel plate electrodes in air under atmospheric pressure has been used to generate ozone in large quantities. However, filamentary discharge is of limited use for surface treatment of materials, since the plasma filaments tend to puncture or treat the surface unevenly and are associated with relatively high plasma current densities.

Instabilities may occur at any time during the breakdown of a plasma, and in particular its has been observed that circumstances at the breakdown of a plasma pulse, but also at the end of a plasma pulse (e.g. generated using an AC voltage), may result in the development of instabilities. These instabilities may develop into major plasma instabilities, such as streamer formation, glow to arc transitions or glow discharge extinction.

European patent application EP-A-1 548 795 discloses a method and arrangement for suppressing instabilities in APG plasma at the start of a plasma pulse. This is being accomplished by obtaining a sharp relative decrease of displacement current by controlling the voltage applied to the electrodes to have a negative change in time (dV/dt) at the start of the plasma pulse.

An inductance in saturation, which is positioned in series with the electrodes, may be used to implement such a control mechanism. Also, an electronic feedback circuit may be used to implement the feedback voltage control. In this prior art publication plasma stabilization by control of displacement current and voltage is proposed. It is claimed, that the streamers current can be controlled as a statistical family by the displacement current and suppressed by a drop of voltage. However this method is difficult to use in the early stage of the discharge at the breakdown as a too large voltage drop will suppress the plasma altogether, and no glow can be born.

### SUMMARY OF THE INVENTION

The present invention seeks to provide a method and arrangement for controlling an APG plasma with improved controllability of the plasma breakdown and ability to provide a very uniform glow discharge.

According to the present invention, a method according to the preamble deftned above is provided, in which controlling the discharge comprises applying a displacement current with a rate of change d/Ildt for controlling local current density variations associated with a plasma variety having a low ratio of dynamic to static resistance. The low ratio of dynamic to static resistance (r/R) is e.g. equal to or lower than 0.1, Plasma varieties having a low ratio of dynamic to static resistance are e.g. filamentary plasmas, which are characterized by local perturbation of current density (e.g. in areas as small as 10 μm²). A glow plasma is characterized by a relatively high dynamic to static resistance, having a value around 1. The capacitive impedance of at least one of the electrodes may be provided by a dielectric barrier electrode, or as a capacitor in series with the electrode. Also, in operation a plasma sheath may be formed when using two metal electrodes, which also provides the capacitive impedance. The tendency of a plasma of having a larger or smaller current density is reflected in its dynamic resistance. The plasma current density will follow a relative rate of change of displacement current dI/Idt with a certain delay time which is independent of the area of perturbation. Thus, even local current density variations are individualized by their respective dynamic resistance. This means that even very locally the current of large density varieties (filaments) will closely follow even fast variations of the displacement current so they can be boosted or damped. The lower current density varieties will not be able to follow the fast displacement current variations. In this way the control of temporal and spatial density of filaments may be controlled by the displacement current. Even very local perturbations having a low ratio of dynamic to static resistance which can not be detected by any electronics can be controlled in this way. More generally the probability of formation of varieties of a current density is controlled by the variation of displacement current during plasma generation. The present method thus offers a solution to control locally the probability of formation of high current density varieties (filaments), for any plasma. The present method may be used to control the characteristic of the generated atmospheric pressure plasma. It may be used to suppress any unwanted instabilities in order to obtain a glow discharge plasma with a high as possible uniformity. On the other hand, the present method may also be used to stimulate the occurrence of filamentary discharges, e.g. useable for generating ozone in an atmospheric environment.

In the present control method and arrangement for controlling instabilities, two stages of a plasma generation may be specifically controlled using a single control method. In this embodiment, the displacement current rate change is applied at least at the breakdown of a plasma pulse. By suppressing instabilities at least at this stage, no filamentary discharges can develop, and a stable glow discharge plasma is formed. Furthermore, the displacement current rate of change may additionally be applied also at the cut-off of the plasma pulse, to provide an even better suppression of instabilities. The displacement current rates of change may be applied using fast relative variations of displacement current.

In a further embodiment, the displacement current rate of change is provided by applying a rate of change in the applied voltage dV/Vdt to the two electrodes, the rate of change in applied voltage being about equal to an operating frequency of the AC plasma energizing voltage, and the displacement current rate of change dI/Idt having a value at least five times higher than the rate of change in applied voltage dV/Vdt. The displacement current rate of change is e.g. more than 10 times as high, even a more than 100 times higher value may be used. This will result in a noticeable suppression of filamentary plasma development at the start of the plasma pulse, and at the same time allows a uniform and stable glow plasma to form.

The controlling of the plasma may, in a further embodiment, be obtained by an LC matching network comprising a matching inductance and a system capacitance formed by the two electrodes and the discharge space (or the total capacity of the APG generator, including wirig capacitances, etc.). Furthermore, a pulse forming circuit in series with the electrodes is provided in this embodiment for providing a synchronization with the plasma breakdown. The pulse forming circuit may be provided connected to either one of the electrodes, or pulse forming circuits may be provided for each of the electrodes. The LC matching network has a resonance frequency of about the operating frequency of the AC plasma energizing voltage. The combination of LC matching network and pulse forming circuit according to this embodiment provides for a synchronization of the frequency of the pulse forming circuit with the plasma breakdown and to generate always a displacement current rate of change.

In a further aspect, the present invention relates to an arrangement as defined in the preamble in which at least one of the electrodes comprises a capacitive impedance in operation, and in which the means for controlling the plasma are arranged to apply a displacement current rate of change for controlling local current density variations associated with a plasma variety having a low ratio of dynamic to static resistance. Furthermore, the means for controlling the plasma may be arranged to execute the method embodiments as described above.

In a specific embodiment, the pulse forming circuit comprises a capacitor, of which the capacity is substantially equal in magnitude to the system capacitance. This is a very simple implementation of the pulse forming circuit, as the serial resonant circuit will be unbalanced by the need of large frequency current at the plasma pulse formation and the displacement current provided by the power supply will tend to drop due to the forcing of the power supply to provide large currents.

In other embodiments, use is made of a choke in the pulse forming circuit, which is arranged to go into saturation at the moment of plasma breakdown. Only after exploiting a resonance of the choke which triggers a jump on the plasma current and discharge of the APG capacity, a drop of displacement current and of voltage is generated using the circuitry of this embodiment. A jump in the displacement current is attenuating the effect of the time decay of the displacement current. The choke operation is based on discharging a capacitor generating a pulse and a resonance between this pulse and the plasma. Due to the resonant circuit, the effects of the choke impedance variation due to saturation are maximized and the displacement current drop is synchronized with plasma breakdown.

In one particular embodiment (parallel resonant circuit), the pulse forming circuit comprises a choke and a pulse capacitor connected in parallel to the choke, in which the choke is dimensioned to saturate substantially at the moment of the plasma breakdown. The pulse forming circuit has a resonance frequency of about the operating frequency of the AC plasma energizing voltage. In this case, the pulse forming circuit has an overall capacitive impedance. This pulse forming circuit is adapted to provide the pulse shaping of the current necessary to provide the control of the displacement current.

In a further particular embodiment (LC series resonant circuit), the pulse forming circuit comprises a series circuit of a choke and a resonator capacitor, and a pulse capacitor connected in parallel to the series circuit, in which the choke is dimensioned to saturate substantially at the moment of the plasma breakdown, and the pulse forming circuit has a resonance frequency of about the operating frequency of the AC plasma energizing voltage. This type of circuit allows a sharper drop of displacement current (higher value of rate of change dI/Idt).

In an even further embodiment, the pulse forming circuit comprises a series circuit of a choke and a resonator capacitor, and a pulse capacitor connected in parallel to the series circuit, in which the choke is dimensioned to saturate substantially at the moment of the plasma breakdown, and the series circuit has an inductive impedance. In this case, the pulse capacitor is used to shift the moment in time of the choke saturating closer to the plasma breakdown.

For the above embodiments using a choke, the LC network may comprise an additional matching circuit capacitor, of which the capacity is substantially equal in magnitude to the system capacitance. This feature will enlarge the APG circuit capacitance, which may enhance the operation and stability of the present control arrangement even further.

In all of the above embodiments of the means for controlling the plasma, fast variations of plasma current (as a result of the high local current densities caused by e.g. filamentary discharges) will provide a trigger to obtain a large drop of displacement current, effectively suppressing instabilities.

By adjusting the above embodiments by providing a trigger to obtain a large pulse in the displacement current the opposite of the stabilization of the APG plasma can be obtained, i.e. the stimulation of filamentary discharge plasma's.

The present invention can be applied for the surface treatment of polymer substrates, such as polyolefin substrates. By using the surface treatment, the contact angle of the polymer substrates may be reduced effectively. For this, a gas mixture may be provided in the plasma discharge space, which gas mixture comprises noble gases such as Neon, Helium, Argon, and Nitrogen or mixtures of these gases. The gas mixture may further comprise NH₃, O₂, CO₂ or mixtures of these gases. Even in the presence of small amounts of oxygen or water vapor, it is possible to create a uniform glow discharge plasma, and to effectively reduce the contact angle of the substrate. The present invention allows the use of an operational frequency of more than 1 kHz, e.g. more than 250 kHz, e.g. up to 50 MHz, which allows to increase the power density of the generated plasma until levels never reached before, e.g. comparable or higher than obtainable by corona discharge.

Unless it is mentioned otherwise below, the description of the processes and/or measures to stabilize the glow plasma in accordance with the invention is mainly provided for the positive half cycle of the displacement current. An identical description for the negative half cycle of the displacement current can be equally provided by changing the sign to the opposite. Hence, the prevention of filament generation can be achieved, in accordance with the present invention, by sharply increasing the (negative) displacement current amplitude during the plasma breakdown in the negative cycle

The arrangement and method according to the present invention can be used, in practice, for a wide variety of applications such as, but not limited to, a device for plasma surface treatment of a substrate, such as surface activation processes, which substrate can be glass, polymer, metal, etc., and for the generation of hydrophilic or hydrophobic surfaces; a plasma device for a chemical vapour deposition process; a plasma device for decomposition of volatile organic compounds; a plasma device for removing toxic compounds from the gas phase; a plasma device for surface cleaning purposes such as in the sterilisation or dry cleaning processes.

Also, the present method and arrangement may be used for controlling breakdown of a plasma in a discharge device in general. The discharge device is one of the group of: a high pressure discharge lamp, a UV discharge lamp, a radio frequency reactor and the like.

### SHORT DESCRIPTION OF DRAWINGS

The present invention will be discussed in more detail below, using a number of exemplary embodiments, with reference to the attached drawings, in which

FIG. 1 shows a simplified diagram of a plasma generation arrangement according to a prior art system;

FIG. 2 shows a diagram of a typical voltage—current characteristic of an APG plasma breakdown;

FIG. 3 shows an electrical diagram of an embodiment of the present invention;

FIG. 4 shows a more detailed diagram of an embodiment of the present invention; and

FIG. 5 shows a more detailed diagram of a further embodiment of the present invention.

### DETAILED DESCRIPTION OF EXEMPLARY EMBODIMENTS

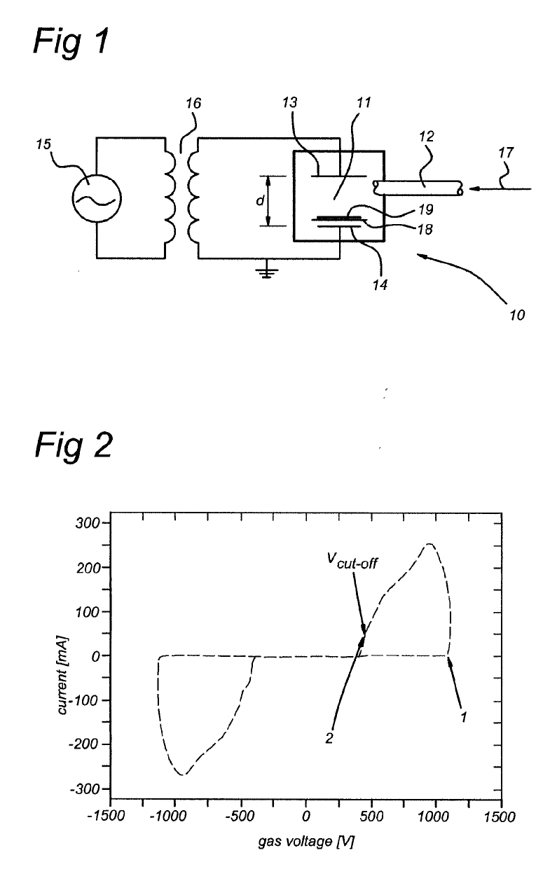

FIG. 1 shows a schematic embodiment of a commonly known Atmospheric Pressure Glow discharge (APG) plasma apparatus or device 10. The apparatus 10 comprises a plasma discharge space 11 (optionally located in a plasma chamber as shown in FIG. 1) and means 12 for supplying a gas or a gas mixture under atmospheric pressure conditions in the discharge space 11, indicated by arrow 17. For producing and sustaining a glow discharge plasma in the plasma discharge space 11, for treating a surface 19 of a body 18, at least two oppositely spaced electrodes 13 and 14, in the discharge space 11 connect to AC power supply means 15, preferably AC power means, via an intermediate transformer stage 16. The frequency of said AC power supply means is selected between 1 kHz and about 50 MHz, e.g. at about 250 kHz.

Although two oppositely spaced electrodes 13 and 14 at a distance d are shown, the apparatus 10 may comprise a plurality of electrodes, which not necessarily have to be arranged oppositely. The electrodes 13, 14 may be positioned adjacently, for example. At least one of the electrodes is preferably covered by dielectric material having a secondary electron emission between 0.01 and 1.

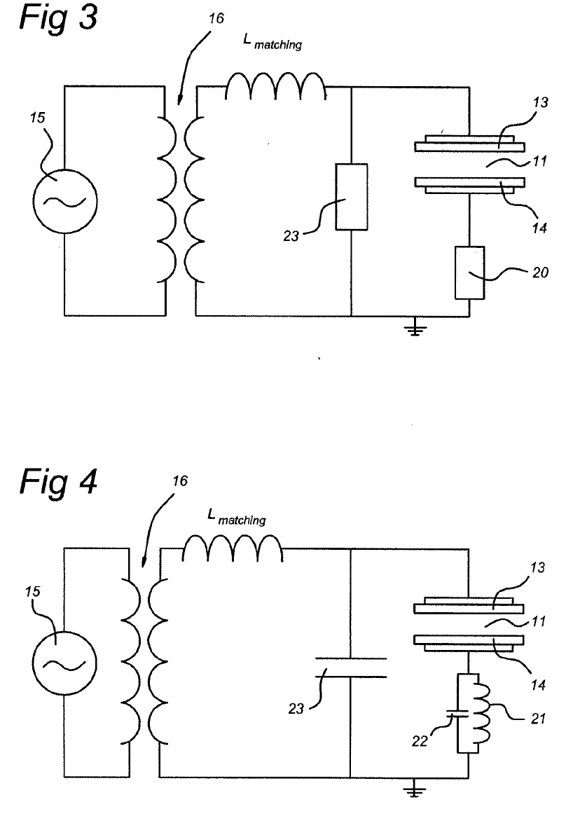

An exemplary embodiment of a plasma control arrangement according to the present invention is shown in FIG. 3 In this figure an impedance matching arrangement is provided in the plasma control arrangement, in order to reduce reflection of power from the electrodes 13, 14 back to the power supply (i.e. AC power supply means 15 and intermediate transformer stage 16 when present). In the embodiments described below, such an impedance matching arrangement is provided, but not further discussed for sake of clarity. The impedance matching arrangement may be implemented using a known LC parallel or series matching network, e.g. using a coil with an inductance of L_{matching} and the capacity of the rest of the arrangement (i.e. formed mainly by a parallel impedance 23 (e.g. a capacitor) and/or the capacitance of the discharge space 11 between the electrodes 13, 14). However, such an impedance matching arrangement cannot filter high frequency current oscillations, which may occur during plasma breakdown.

The high frequency supply 15 is connected to the electrodes 13, 14 via intermediate transformer stage 16 and matching coil with inductance L_{matching}. Furthermore, a pulse forming circuit 20 is connected to the lower electrode 14. A further impedance 23 is connected in parallel to the series circuit of electrodes 13, 14 and pulse forming circuit 20.

In FIG. 2 a typical voltage—current characteristic is shown for the generation of a APG plasma. The plasma is generated using an AC applied voltage, which initially rises without any current flowing. At a point of applied voltage over the breakdown voltage, a plasma is formed between the electrodes 13, 14 and the current rapidly rises. The plasma pulse reaches a maximum intensity (corresponding to the maximum current) and then decreases until a cut-off value V_{cut-off} of the applied voltage is reached, after which the current returns to substantially zero. For the negative AC voltage cycle, the same process is repeated. The two moments in the plasma pulse generation, control according to an embodiment of the present invention are indicated by the reference numerals 1 (application of rate of change in displacement current to suppress instabilities at plasma breakdown) and 2 (application of rate of change in displacement current to suppress instabilities at plasma cut-off).

More in general, the present invention aims to provide a method to control very locally, i.e. in regions of a plasma filament (˜10 um² size), the current density of a generated plasma. This is done by exploiting the fact that the tendency of a plasma of having a larger or smaller current density is reflected in its dynamic resistance r:

$$r = \frac{d V}{d I} = \frac{d V}{d ( {j}_{PLASMA}^{LOCAL} * S )}$$

in which j is the local current density and S is the surface of the local plasma. If a plasma is e.g. in contact with a dielectric barrier (e.g. of one of the electrodes 13, 14) a RC circuit is formed. The capacity may also be formed in operation using two metal electrodes 13, 14, when a plasma sheath is formed. Also, an external capacitor may be connected in series with one of the electrodes 13, 14. This plasma current density will follow a relative change of displacement current dI_{d}/Idt with a delay τ given by:

$$τ = {rC}_{d} = \frac{d V}{d ( {j}_{PLASMA}^{LOCAL} S )} * \frac{ɛ S}{d} = \frac{d V}{d ( {j}_{PLASMA}^{LOCAL} )} * \frac{ɛ}{d}$$

in which ∈ is the permittivity in the discharge space 11 and d is the distance between the electrodes 13, 14.

This delay is independent of the area of perturbation so even local perturbations of current density are individualized by their RC constant. This means that even very locally the current of large density varieties of a plasma (which have a low ratio of dynamic to static resistance (r/R<0.1), e.g. filaments) will closely follow even fast variations of the displacement current so these varieties can be boosted or damped. The lower current density varieties (which have a high ratio of dynamic to static resistance r/R, e.g. about 1 for glow discharges) will not be able to follow the fast displacement current variations. In this way the control of temporal and spatial density of filaments may be controlled by the displacement current. Even very local perturbations which can not be detected by any electronics can be controlled in this way.

More generally the probability of formation of varieties of plasma's with a specific current density is controlled by the variation of displacement current during plasma generation. The present method thus offers a solution to control locally the probability of formation of high current density varieties (filaments), for any plasma.

Because the filamentation is more probable at the plasma breakdown and plasma extinction, for suppressing the filamentary discharges the following equation is observed:

$${τ}_{breakdown} \frac{d {I}_{d}}{d {tI}_{d}} \leq - 1$$

where τ_{breakdown} is the time of breakdown development (which in general is in the range of hundred of nanoseconds).

More general the following equation is observed:

$${τ}_{instabil\_growth} \frac{d {I}_{d}}{d {tI}_{d}} \leq - 1$$

where τ_{instabile}_{_{—}}_{growth} is the time of growth of instabilities also typically in the range of hundred of nanoseconds. So, ideally dI_{d}/Idt must be in the ten MHz range.

It is noted that the above relates to the conditions for damping the filamentary discharges. The present method may also be applied to enhancing or boosting the filamentary discharges. For boosting, the above products must be larger than or equal to one.

As a rule, fast relative variations of displacement current must be used to control the plasma. It is technically difficult to generate such large variations during all the duration of the plasma discharge. In an exemplary embodiment, therefore, robust displacement current pulses are generated in the critical regions of the breakdown and plasma extinction where the risk of instabilities is larger.

The pulse forming circuit 20 is arranged to obtain the desired pulse shaping in order to suppress (or enhance) instabilities, which may possibly form at the pulse breakdown (onset of plasma pulse) and also to suppress (or enhance) instabilities at the end of the plasma pulse (after the plasma pulse maximum).

In embodiments of the present application, the main idea is to use the pulse forming circuit 20 in series with a resonant LC series circuit (i.e. the impedance matching arrangement). In this way when the plasma pulse forms (having a duration much shorter than the half period of the sine of the AC applied voltage) the serial resonant circuit will be unbalanced by the need of large frequency current (due to the forcing of the power supply 15 to provide large currents) and the displacement current provided from the power supply will tend to drop. The most simple implementation of the pulse forming circuit 20 is a capacitor in series with the plasma electrodes 13, 14. In order to be efficient its capacity must be comparable with the plasma reactor capacity (i.e. capacitance of discharge space 11 between electrodes 13, 14). Such a circuit was proved efficient in the case of N₂ HF discharges and sometime even in the case of Ar HF discharge.

In prior art systems, a choke in saturation has been used as a pulse forming circuit 20, however, the complex timing with the plasma pulse generation poses additional problems. In the exemplary embodiments of the present invention as described below, again a choke 21 is used as non-linear element, but with further additional elements. The choke operation is based on discharging a capacitor for generating a pulse and a resonance between this pulse and the plasma.

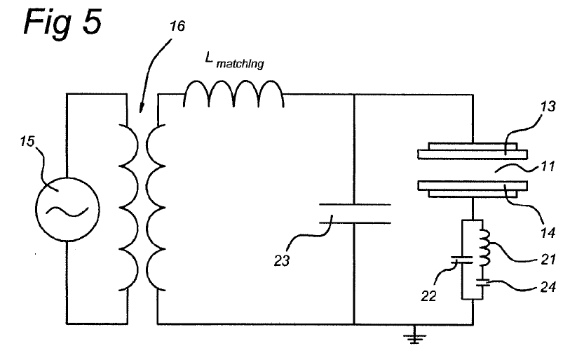

A new arrangement was designed in order to synchronize the choke 21 with the plasma breakdown and to generate a displacement current. In this design the choke 21 is mounted in series with the plasma electrodes 13, 14 (which form a capacitor) and a series resonant circuit is formed (see embodiments illustrated in FIGS. 4 and 5). The choke 21 is at its turn mounted in parallel with a capacitor 22 (Cₚᵤₗₛₑ) thus forming the pulse forming circuit 20. The circuit 20 of capacitor 22 (Cₚᵤₗₛₑ) and choke 21 (L_{choke}) are chosen to be resonant at the frequency of the power supply 15. Due to the resonant circuit the effects of the choke impedance variation due to saturation are maximized and the displacement current drop is synchronized with plasma breakdown. Until the plasma breakdown the current flowing through the circuit (i.e. electrodes 13, 14) is consisting mainly of the resonant frequency RF component and the resonant circuit is resistive with a resistance R_{rlc}. After the plasma breakdown large current components of RF frequency are generated and the choke 21 becomes saturated (i.e. has a low impedance) but the impedance of the resonant circuit increases. Thus the choke-capacitor circuit becomes quasi-capacitive and the voltage on the bottom electrode 14 has a fast jump from WIC to I/ωC₍ₚᵤₗₛₑ₎. In this way a drop of displacement current is generated.

At low plasma currents when the choke 21 is not saturated (and has a value L_{choke}) the plasma pulse having higher frequencies does not pass through the resonant circuit but through the larger impedance 22 with capacity Cₚᵤₗₛₑ.

A first embodiment of the plasma control arrangement for the APG apparatus 10 with such a pulse forming circuit 20 is shown schematically in FIG. 4. In such a control arrangement a drop of voltage on the choke 21 is generated due to the decrease of choke impedance at saturation (Lₛₐₜᵤᵣₐₜᵢₒₙ) causing the short-circuit of the capacitor 22 in parallel with the choke 21. In the embodiment of FIG. 4 the choke 21 is mounted at the ground side (i.e. electrode 14). The pulse forming circuit can also be mounted at the HV side in which case choke 21 is mounted on the HV side (electrode 13). It is also possible to use a pulse forming circuit at both the ground side and the HV side. The shown parallel capacitor 23 is indicative for the sum of the capacity inserted, the capacity of the high voltage (HV) wire to electrode 13 and of the HV electrode 13 to the ground (i.e. a total value of Cₚₐᵣₐₗₗₑₗ).

A resistor with impedance R can also be used instead of the choke 21 if it has a non-linear characteristic in which its impedance is suddenly changed from high to low. For the sake of simplicity, first this circuit will be discussed using a resistor R instead of the choke 21. In this case the voltage on the resistor will be:

$$V = {V}_{0} * exp ( - \frac{t}{{R}_{pulse} {C}_{pulse}} )$$

where Rₚᵤₗₛₑ. is the resistance of the resistor in low impedance state, Cₚᵤₗₛₑ is the capacity of the capacitor 22 in parallel with the resistor R and V₀ is the initial voltage before the triggering of the impedance drop. With regard to the displacement current variation this depends on the voltage variation on the APG apparatus 10 which in turn is dependent on the parasite capacity of wires and electrodes connected in series with the APG reactor (i.e. the space between electrodes 13, 14). If one assumes that the pulse current is so high that it can not be provided by the power source 15, then the energy to power it must be provided by the capacitor 22 (i.e V₀/Rₚᵤₗₛₑ>>I_{generator}), and the following applies:

$$V \approx {V}_{applied} * \frac{1}{1 + \frac{{C}_{pulse}}{{C}_{APG}}}$$

For an efficient pulse breakdown the voltage variation produced by the RC pulse circuit must be much larger than generated by the power source 15.

For ensuring the condition that the parasite capacity is much larger than the APG capacity a large capacity 23 is inserted in parallel with the APG electrodes 13, 14 if the RC pulse system 20 is connected to the bottom electrode 14. In this way the capacity of the LV electrode 13 to the ground will be increased. If the RC pulse system 20 is connected to the HV electrode 13 then the capacity of the bottom electrode 14 to the ground must be increased by mounting a larger capacity in series.

It is also important, that the value of capacitor 22 (Cₚᵤₗₛₑ) is comparable with the APG capacity (C_{APG}). The impedance must be much larger than that of the resistor R (before the voltage drop) because otherwise the capacitor 22 can not be charged to a significant voltage.

If one would rely just on the wires parasite capacity the effect of the pulse forming circuit 20 system may be quasi-null because then C_{APG}/Cₚₐᵣₐₗₗₑₗ>>1 and Cₚᵤₗₛₑ<<C_{APG}. If the conditions for the circuit optimization are fulfilled than the displacement current drop is given by:

$$\frac{d {I}_{d}}{d {tI}_{d}} \approx \frac{- 1}{{R}_{pulse} * {C}_{pulse}}$$

This equation is valid only during the time when the voltage variation of the pulse forming circuit 20 is significant i.e. for a time period in the order of RₚᵤₗₛₑCₚᵤₗₛₑ. If the Rₚᵤₗₛₑ is large but not too large (Rₚᵤₗₛₑ≈1/ωCₚᵤₗₛₑ) than the total current in the circuit will be not perturbed too much by the pulse generation and the displacement current on the APG capacitor (between electrodes 13, 14) however will drop with a rate approximately given by this equation. With the notable exception of the above case of low current pulses the RC parallel pulse system generates actually a displacement current pulse defined by a sudden increase of displacement current at the moment of impedance drop which is attenuated afterward. So the reduction of filamentation degree can be well negligible.

In a useable embodiment, not a resistor R is used as non-linear element, but a choke 21, as depicted in FIG. 4. One may simplify assuming that when the choke 21 is unsaturated, it has an inductance L_{choke} and when saturated switches directly to a smaller impedance L_{saturated}, and the above equation for dI_{d}/I_{d}dt can be rewritten as:

$$\frac{d {I}_{d}}{d {tI}_{d}} \approx \frac{- 1}{\sqrt{{L}_{saturated} {C}_{pulse}}}$$

For an efficient dI_{d}/I_{d}dt generation the drop of displacement current (logarithmic derivative) is in the order of at least 1/μs. When a choke 21 is used instead of a resistor R than several supplementary conditions are considered. For example, the choke 21 will be saturated before plasma breakdown, but this saturation will not affect significantly the LC resonant circuit powering the system formed by L_{matching} and the rest of capacities present in the APG apparatus 10. The perturbation of the resonant circuit 20 is due to the fact that when the choke 21 is saturated, the capacitor 22 (Cₚᵤₗₛₑ) is in short circuit and the capacity of the APG apparatus 10 increases. For avoiding perturbation of the resonant circuit 20 the following requirement is set:

$$\frac{{C}_{APG}}{{C}_{parallel} ( 1 + \frac{{C}_{APG}}{{C}_{pulse}} )} << 1$$

So again, a capacitor 23 with a larger capacity Cₚₐᵣₐₗₗₑₗ is mounted in parallel with the series circuit of APG electrodes 13, 14 and pulse forming circuit 20 in this embodiment.

For saturating the choke 21, the current through the choke 21 calculated when the amplitude of the applied voltage is equal to the breakdown voltage of the plasma pulse, is at least equal to the saturation current. However the choke 21 can not saturate well before the plasma breakdown or otherwise the pulse generated by the choke saturation will end before the plasma breakdown. So the condition is that the choke 21 will be still be saturated when the voltage on the APG plasma is equal to the breakdown voltage U_{br}.

$${I}_{choke}^{max} = \frac{{U}_{br} ω {C}_{APG}}{\vert {ω}^{2} {L}_{choke} {C}_{pulse} - 1 \vert}$$

$${I}_{sat} = 0.6 - 0.7 * {I}_{choke}^{max}$$

where I^{max}_{choke} is the maximum possible current through the choke 21 (if the choke 21 would not saturate), i.e calculated taking in account the unsaturated impedance of the choke L_{choke}. I^{max}_{choke} has a resonance when ω²*L_{choke}*Cₚᵤₗₛₑ=1. This allows that the choke 21 will be saturated with low voltage (and power applied to APG) so it allows operation for plasmas with lower breakdown voltages. However the voltage drop on the pulse system also has a resonance when ω²*L_{choke}*Cₚᵤₗₛₑ=1 so a larger total voltage should be applied to the system.

Expressed as a function of the voltage of the power source 15 the resonance of the choke current shifts to ω²L_{choke}(C_{APG}+Cₚᵤₗₛₑ)=1. Note that only if ω²L_{choke}Cₚᵤₗₛₑ>1 it is likely that a large impedance drop of the choke 21 will be generated as a result of the choke saturation. When the choke 21 will start to saturate the impedance decreases but in order to enhance the saturation the current on the choke 21 must increase. If this condition is satisfied as a result of the saturation the choke 21 will generate a high voltage current pulse having a frequency band around the resonant frequency of the pulse forming circuit

$${ω}_{choke} = \frac{1}{\sqrt{{L}_{saturated} {C}_{pulse}}}$$

The mechanism of the displacement current drop is described below. During the plasma breakdown a displacement current drop and a voltage drop may be obtained due to the excitation of resonance's as a result of the change in current frequencies band as a result of the plasma breakdown. This is due to an impedance resonance. The impedance has a minimum at ω²*L_{choke}*(Cₚᵤₗₛₑ+C_{APG})=1. When plasma is ON the APG capacity of the plasma is short circuited by the plasma and then the only remaining capacity in series with the pulse forming circuit 20 is mainly of the ionic sheath which is comparable with the APG capacity. The dielectric capacity is negligible in comparison with those of the sheath. So the new resonance is obtained for frequencies ωᵣₑₛ at which: ω²*L_{saturated}*(Cₚᵤₗₛₑ+C^{P}_{APG})=1 where C^{P}_{APG}, is the equivalent capacity of the APG with plasma ON. If the frequency band of the choke 21 is coincident with the plasma characteristic frequencies the current to the plasma will be boosted and the APG capacity and parallel capacity 23 will discharge and a drop of voltage and of displacement current will be generated.

The mechanism of voltage and displacement current drop consists of following steps:

when the plasma is OFF due to the change of impedance the current resonance frequencies is changed to a value comparable with the plasma characteristic frequencies.

if APG equivalent capacity is comparable with Cₚᵤₗₛₑ the voltage increase pulse generated by the saturated choke 21 has also frequencies in the band of the current resonance and a plasma current resonance is triggered.

the voltage on the APG plasma decreases due to the large currents.

The above conditions are allowing only a limited range of values for ω²*L_{choke}*Cₚᵤₗₛₑ=1 because they are linked to resonances.

To conclude the important design criteria are:

pulse system capacity comparable with that of APG capacity;

Cₚₐᵣₐₗₗₑₗ>C_{APG};

L_{saturated}<L_{choke} (which is a condition for selection of the ferrite core of the choke 21);

L_{saturated}*Cₚᵤₗₛₑ<10⁻¹²s²;

ω²ₚₗₐₛₘₐL_{saturated}(C_{APG}+Cₚᵤₗₛₑ)=1;

ω²L_{choke}Lₚᵤₗₛₑ>2−3 for achieving choke saturation and a large inductance decrease, or in the case of the ultra-strong saturation resonance when choke impedance is mainly a resistor: ω²L_{choke}Cₚᵤₗₛₑ=1.

An alternative embodiment of the present invention is discussed now with reference to the schematic view of FIG. 5. In parallel with the pulse capacitor 22 is mounted a series resonant LC circuit, comprising the choke 21 and a further capacitor 24 with a capacity of Cᵣₑₛ. It will be clear that the choke 21 of this embodiment may have different characteristics from the choke 21 used in the FIG. 4 embodiment. The capacity Cᵣₑₛ of further capacitor 24 is set in such a way that the circuit will be resonant at the operating frequency of the APG apparatus 10.

$${C}_{res} = \frac{1}{{ω}^{2} L}$$

Firstly, in this case the choke 21 is prevented to be saturated by the discharge of capacitor 22 (Cₚᵤₗₛₑ). This will happen only when the frequency becomes equal to:

$${ω}_{res}^{2} = \frac{1}{{L}_{choke} ( {C}_{pulse} + {C}_{res} )}$$

Until the plasma breakdown, the current flowing through the circuit is consisting mainly of the resonant frequency RF component and the resonant circuit is resistive with a resistance R_{rlc}. After the plasma breakdown large current components of RF frequency are generated and the choke 21 becomes saturated (i.e. has a lower impedance) and the impedance of the resonant circuit increases. At low plasma currents when the choke 21 can not saturate, the plasma having larger frequencies does not pass through the resonant circuit but through the larger impedance Cₚᵤₗₛₑ of capacitor 22. Thus the choke-capacitor circuit becomes quasi-capacitive and the voltage on the bottom electrode 14 has a fast jump of at least

$$Δ V = \frac{{I}_{plasma}}{ω {C}_{pulse}} - {I}_{d} * {R}_{r / c}$$

If the effect of the choke saturation is taken in to account the jump can be larger i.e

$$Δ V = \frac{{I}_{plasma}}{ω {C}_{pulse}} + \frac{{I}_{d}}{ω {C}_{res}} - {I}_{d} * {R}_{r / c}$$

For maximization of the voltage jump in this embodiment, the following condition is dictated:

1/ω(Cₚᵤₗₛₑ+Cᵣₑₛ<<R_{rlc}

Also, the choke 21 must barely saturate around the plasma breakdown in order to be pushed to a stronger saturation by plasma current, and thus:

Iₛₐₜ=0.8U_{br}ωC.

One can see in the above conditions that the voltage jump is dependent on the plasma current so the feedback is dependent on the plasma current (so a feedback at low current is minimal). A solution may be to arrange the inductance saturation currents in such a way that at the plasma breakdown the choke 21 will be more saturated without any contribution from the plasma. In this case a jump of voltage can be generated due to the choke saturation.

The choke and capacitor parallel arrangement of the embodiment illustrated in FIG. 4 has the advantage of the longer pulses but also slower drops of displacement current. The choke and capacitor in series arrangement of the embodiment illustrated in FIG. 5 has the advantage of a good synchronization with plasma and of sharper drops of displacement current (which is optimum for the breakdown). Nevertheless the duration is limited to the breakdown and/or cut-off region. A simultaneous mounting of both embodiment (e.g. one of them connected to the HV electrode 13 and the other one at the bottom electrode 14) may provide even better results.

Also two parallel arrangements on either side of the APG electrodes 13, 14 or two series arrangements on either side of the APG electrodes 13, 14 or even a parallel arrangement on one side and a series arrangement on the other side gives a further stability improvement.

An even further embodiment has the same structure as the embodiment of FIG. 5, but in this case the pulse forming circuit 20 is not necessarily to be resonant, but must have an overall inductive impedance. The capacitor Cᵣₑₛ 24 is used in this embodiment to shift the moment of saturation of choke 21 closer to the plasma breakdown.

### EXAMPLES

The present method and control arrangement have been used in an experimental set-up for treating the surface of a polymer material.

Standard APG systems operating at atmospheric pressure using Ar and N2 or pure N2 are very unstable and therefore not suitable for industrial applications. Furthermore, the power density's applied in the APG plasma (typically <<1 W/cm2) are lower than in corona equipment (up to 6 W/cm2). Increasing the excitation frequency enhances the power density (effectiveness) of the plasma, however, under normal conditions the discharge becomes Localized in streamers which decreases the homogeneity of the treatment very much.

In the present atmospheric pressure dielectric barrier discharge (DBD) set-up an APG plasma is generated at a high frequency (HF) using Ar—N2 mixtures or pure nitrogen where the plasma stability is controlled by controlling the displacement current (by using a dedicated matching network) which provides a very strong and uniform surface energy increase. The HF source is used to increase the power density of the plasma to typically 6 W/cm², so comparable to corona discharges. Without the stabilizing means in the form of the control arrangement according to the present invention, the discharge is strongly filamentary whereas utilizing the stabilizing means the discharge switches in to homogeneous and diffuse glow plasma.

For reference, a small Softal corona treater type VTG 3005 (Corona Discharge Treatment) unit equipped with ceramic bars was used to treat the (poly-ethylene (PE) and) polypropylene (PP) samples with different plasma dose. A gradual decrease of contact angle appears with increase of plasma dose. However, the lowest obtainable contact angles with practical plasma dose is typically 60° for PE and 65° for PP. Increasing the plasma dose to higher levels causes the surface of the polyolefin to become dull, which is due to formation of Low Molecular Weight Oxidized Materials (LMWOM). As a function of exposure time, the contact angle lowers asymptotically to the lowest value.

In a set-up using the control arrangement according to the present invention, the electrode set-up consists of a standard flat plate Dielectric Barrier Discharge (DBD) configuration. Both electrodes 13, 14 are covered with a dielectric. The top electrode 13 consists of a fixed dielectric and the bottom electrode 14 contains the polyolefin to be treated by the plasma. The DBD system is powered by a high frequency power supply 15 including a high voltage transformer 16 (see FIG. 3). The system is operated at a resonance frequency of 240 kHz, and the gas supplied to the APG electrode consisted of argon and nitrogen in a ratio of 5 to 1. The forwarded power density is about 5 W/cm². Because a static set-up was used the polyolefin was fixed on the bottom electrode 14. Since short exposure times are the most interesting (less than 1 second) the plasma was pulsed. Two different pulse durations 100 ms and 25 ms were applied in order to realize the required exposure range. It was found that the Argon nitrogen plasma of the latter set-up is much more effective, enabling a reduction of the contact angle up to about 30°, already after 0.5 seconds of treatment. Moreover, the treatment is very uniform since it is an APG plasma and very stable comparable to other low frequency APG plasmas. In general, a gas mixture of argon and 1-50% of nitrogen (e.g. 10-30% of nitrogen), or a substantially pure nitrogen gas provides adequate results. Even when a substantial amount of oxygen or water pollution is present, a stable and high energy APG plasma can be generated.

It has been found that a control arrangement according to the present invention can also be used in various other applications besides the generation of an atmospheric pressure glow discharge for surface treatment and the like. Other types of plasma in sub atmospheric or pressurized environments may be generated, e.g. in the range between 0.1 and 10 bar. Any device in which varieties are formed using an electric field between electrodes, such as high pressure discharge lamps, UV lamps and even radio frequency generators may benefit from the increased stability control provided by the present invention.

Although in the above oppositely positioned electrodes have been discussed and shown in the relevant figures, the invention may also be practised with adjacently arranged electrode pairs or other configurations of electrodes of an APG apparatus.

Those skilled in the art will appreciate that many modifications and additions can be made without departing from the novel and inventive scope of the invention as defined in the appending claims.

1. A method for generating and controlling a discharge plasma in a gas or gas mixture, in a plasma discharge space having at least two spaced electrodes, in which at least one current pulse is generated by applying an AC plasma energizing voltage to the electrodes causing a plasma current and a displacement current, the method for controlling the discharge plasma comprising applying a displacement current rate of change dI/Idt for controlling local current density variations associated with a plasma variety having a low ratio of dynamic to static resistance.

2. The method according to claim 1, comprising applying the displacement current rate of change at least at the breakdown of a plasma pulse.

3. The method according to claim 1, comprising applying the displacement current rate of change at least at the breakdown of a plasma pulse and at the cut-off of the plasma pulse.

4. The method according to claim 1, in which the displacement current change is provided by applying a rate of change in the applied voltage dV/Vdt to the two electrodes, the change in applied voltage being about equal to an operating frequency of the AC plasma energizing voltage, and the displacement current rate of change dI/Idt having a value at least five times higher than the rate of change in applied voltage dV/Vdt.

5. The method according to claim 1, in which the controlling of the plasma is obtained by an LC matching network comprising a matching inductance (L_{matching}) and a system capacitance formed by the two electrodes and the discharge space, and a pulse forming circuit in series with at least one of the electrodes.

6. The method according to claim 5, in which the LC matching network has a resonance frequency of about the operating frequency of the AC plasma energizing voltage.

7. An arrangement for generating and controlling a discharge plasma in a discharge space (having at least two spaced electrodes, means for introducing a gas or gas mixture in the discharge space, a power supply for energizing the electrodes by applying an AC plasma energizing voltage to the electrodes for generating at least one current pulse and causing a plasma current and a displacement current, and means for controlling the plasma, in which the means for controlling the plasma are arranged to apply a displacement current rate of change dI/Idt for controlling local current density variations associated with a plasma variety having a low ratio of dynamic to static resistance.

8. The arrangement according to claim 7, in which the means for controlling the plasma are arranged to apply the displacement current rate of change at least at the breakdown of a plasma pulse.

9. The arrangement according to claim 7, in which the means for controlling the plasma are arranged to apply the displacement current rate of change at least at the breakdown of a plasma pulse and at the cut-off of the plasma pulse.

10. The arrangement according to claim 7, in which the means for controlling the plasma are further arranged to provide the displacement current change by applying a rate of change in the applied voltage dV/Vdt to the two electrodes, the rate of change in applied voltage being about equal to an operating frequency of the AC plasma energizing voltage, and the displacement current rate of change dI/Idt having a value at least five times higher than the rate of change in applied voltage dV % Vdt.

11. The arrangement according to claim 7, in which the means for controlling the plasma comprise an LC matching network formed by a matching inductance (L_{matching}) and a system capacity formed by the two electrodes and the discharge space, and a pulse forming circuit in series with at least one of the electrodes.

12. The arrangement according to claim 11, in which the LC matching network has a resonance frequency of about the operating frequency of the AC plasma energizing voltage.

13. The arrangement according to claim 11, in which the pulse forming circuit comprises a capacitor, of which the capacity is substantially equal in magnitude to the system capacitance.

14. The arrangement according to claim 11, in which the pulse forming circuit comprises a choke and a pulse capacitor connected in parallel to the choke, in which the choke is dimensioned to saturate substantially at the moment of the plasma breakdown, and the pulse forming circuit has a resonance frequency of about the operating frequency of the AC plasma energizing voltage.

15. The arrangement according to claim 11, in which the pulse forming circuit comprises a series circuit of a choke and a resonator capacitor, and a pulse capacitor connected in parallel to the series circuit, in which the choke is dimensioned to saturate substantially at the moment of the plasma breakdown, and the pulse forming circuit has a resonance frequency of about the operating frequency of the AC plasma energizing voltage.

16. The arrangement according to claim 11, in which the pulse forming circuit A comprises a series circuit of a choke and a resonator capacitor, and a pulse capacitor connected in parallel to the series circuit, in which the choke is dimensioned to saturate substantially at the moment of the plasma breakdown, and the series circuit has an inductive impedance.

17. The arrangement according to claim 11, in which the LC matching network comprises an additional matching circuit capacitor (23), of which the capacity is substantially equal in magnitude to the system capacitance.

18. A method for the surface treatment of polymer substrates, comprising treating said surface with discharge plasma from a plasma discharge space having at least two spaced electrodes, in which at least one current pulse is generated by applying an AC plasma energizing voltage to the electrodes causing a plasma current and a displacement current, and controlling the discharge plasma by applying a displacement current rate of change dI/Idt for controlling local current density variations associated with a plasma variety having a low ratio of dynamic to static resistance.

19. The method according to claim 18, method further comprises providing a gas mixture in the plasma discharge space, which gas mixture comprises Neon, Helium, Argon, Nitrogen or mixtures of these gases.

20. The method according to claim 19 in which the gas mixture further comprises NH₃, O₂, CO₂ or mixtures of these gases.

21. The method according to claim 18, in which an operational frequency is used of more than 1 kHz, e.g. more than 250 kHz, e.g. up to 50 MHz.

22. A high pressure discharge lamp, a UV discharge lamp, or a radio frequency reactor comprising an arrangement for generating and controlling a discharge plasma in a discharge space having at least two spaced electrodes, means for introducing a gas or gas mixture in the discharge space, a power supply for energizing the electrodes by applying an AC plasma energizing voltage to the electrodes for generating at least one current pulse and causing a plasma current and a displacement current, and means for controlling the plasma, in which the means for controlling the plasma are arranged to apply a displacement current rate of change dI/Idt for controlling local current density variations associated with a plasma variety having a low ratio of dynamic to static resistance.

23. (canceled)

24. The method according to claim 21, in which the operational frequency is more than 250 kHz.
